(19) United States
(12) Patent Application Publication
(10) Pub. No.: US 2025/0006924 A1
(43) Pub. Date: Jan. 2, 2025

(54) NEGATIVE ELECTRODE FOR SECONDARY BATTERY AND SECONDARY BATTERY COMPRISING THE SAME

(71) Applicant: SK ON CO., LTD., Seoul (KR)

(72) Inventors: Chi Won JEON, Daejeon (KR); Young Jun KIM, Daejeon (KR); Dong Hoon LEE, Daejeon (KR)

(21) Appl. No.: 18/544,444

(22) Filed: Dec. 19, 2023

(30) Foreign Application Priority Data
Jun. 30, 2023 (KR) 10-2023-0085113

(51) Int. Cl. H01M 4/583; H01M 4/62; H01M 10/052

(52) U.S. Cl. CPC H01M 4/583; H01M 4/624; H01M 10/052; H01M 2004/021; H01M 2004/027

(57) ABSTRACT

A negative electrode for a lithium secondary battery and a lithium secondary battery including the same are provided. The negative electrode includes a negative electrode current collector, and a negative electrode mixture layer on at least one surface of the negative electrode current collector. The negative electrode mixture layer includes an negative electrode active material and carbon fiber, and the carbon fiber has an average cross-sectional diameter of 5 to 20 μm.

### CROSS-REFERENCE TO RELATED APPLICATION(S)

This patent document claims the priority and benefits of Korean Patent Application No. 10-2023-0085113 filed on Jun. 30, 2023, the disclosure of which is incorporated herein by reference in its entirety.

### TECHNICAL FIELD

The technology and implementations disclosed in this patent document generally relate to a negative electrode for a lithium secondary battery and a secondary battery including the same.

### BACKGROUND

As the electric vehicle market has recently expanded, interest in lithium secondary batteries is rapidly increasing. In such electric vehicles, the time it takes to charge the battery is recognized as a disadvantage, and thus there is great interest in fast charging, and a large amount of research into shortening charging times has been undertaken.

Generally, in the negative electrode of a lithium ion battery, particles such as a negative electrode active material and the like constituting the electrode mixture are irregularly distributed during a drying process to remove an organic solvent and a rolling process to obtain a required electrode density, and as a result, pores formed between particles present in the electrode mixture layer are also distributed unevenly.

In detail, particles of an anisotropic negative electrode active material, such as graphite, used as a negative electrode active material are oriented horizontally with respect to the electrode current collector, to increase a movement path of lithium ions within the negative electrode mixture layer such that diffusion of lithium ions is slowed, which causes polarization of the battery, and as a result, leads to a decrease in cell performance.

Recently, to prevent the problem of lowering a diffusion rate of lithium ions due to the horizontal orientation of a negative electrode active material as described above and to improve the orientation by utilizing magnetic properties of anisotropic graphite used as a negative electrode active material, a technology for shortening a movement path of lithium ions by applying a magnetic field and orienting the magnetic field perpendicularly to a current collector has been applied to the production of negative electrodes.

However, due to the shape of a graphite negative electrode active material, the overlap between negative electrode active materials, or the like, the lithium ion movement path is not linear, and in some cases, the lithium ion movement path may be severely curved or may be blocked. As a result, there are certain limits to fast charging performance due to shortening of the lithium ion movement path.

### SUMMARY

The disclosed technology may be implemented in some embodiments to provide a negative electrode that may further improve a diffusion rate of lithium ions during rapid charging.

The disclosed technology may be implemented in some embodiments to provide a secondary battery comprising the negative electrode.

In some embodiments of the disclosed technology, a negative electrode includes a negative electrode current collector; and a negative electrode mixture layer on at least one surface of the negative electrode current collector. The negative electrode mixture layer includes a negative electrode active material and carbon fiber, and the carbon fiber has an average cross-sectional diameter of 5 to 20 μm and is oriented in a direction perpendicular to the negative electrode current collector.

The negative electrode mixture layer may include a first layer including a first surface in contact with the negative electrode current collector and a second layer including a second surface outside the negative electrode mixture layer located on a surface opposite to the first surface, and the first layer may include carbon fiber.

The negative electrode may further include at least one negative electrode mixture layer between the first layer and the second layer, and among two adjacent layers, a content of the carbon fiber in the negative electrode mixture layer adjacent to the first surface may be greater than a content of the carbon fiber in the negative electrode mixture layer adjacent to the second surface.

The second layer may include or may not include the carbon fiber.

The carbon fiber may have an average length of 30 to 150 μm.

The carbon fiber may have a density of 1.75 to 1.93 g/cm³.

The carbon fiber may be contained in an amount of 0.5 to 10% by weight based on a total weight of the negative electrode mixture layer.

The negative electrode active material may include graphite.

The negative electrode may have a P/O value of 0.45 or less according to XRD analysis.

The negative electrode active material may have an orientation, perpendicular to the negative electrode current collector.

The negative electrode may have a mean tortuosity value of 1.24 or less.

The negative electrode may further include a conductive agent, and the conductive agent may further include at least one selected from a particulate conductive agent having an average particle diameter of 10 to 500 nm and a fibrous conductive agent having an average fiber diameter of 10 to 500 nm.

In some embodiments of the disclosed technology, a secondary battery includes any one of a positive electrode and the negative electrode described above.

### BRIEF DESCRIPTION OF DRAWINGS

Certain aspects, features, and advantages of the disclosed technology illustrated by the following detailed description with reference to the accompanying drawings.

FIG. 1 is a diagram conceptually illustrating a movement path of lithium ions in a negative electrode not containing carbon fiber.

FIG. 2 is a diagram conceptually illustrating a movement path of lithium ions in a negative electrode not containing carbon fiber and having a negative electrode active material oriented by a magnetic field.

FIG. 3 is a diagram conceptually illustrating a movement path of lithium ions in a negative electrode including carbon fiber according to an embodiment.

FIG. 4 is a diagram conceptually illustrating a movement path of lithium ions in a negative electrode according to an embodiment, including carbon fiber and having a negative electrode active material oriented by a magnetic field.

FIG. 5 is an SEM image of the carbon fiber used in Example 1.

FIG. 6 illustrates a cross-sectional structure of a negative electrode analyzed through XRM for the negative electrode manufactured in Example 1 and Comparative Example 1, in which FIG. 6A is a negative electrode of Example 1, and FIG. 6B is a negative electrode of the comparative example.

### DETAILED DESCRIPTION

Features of the disclosed technology disclosed in this patent document are described by example embodiments with reference to the accompanying drawings.

Hereinafter, the disclosed technology will be described in detail with reference to the attached drawings, but this is merely illustrative, and the disclosed technology is not limited to the specific embodiments described below by way of example.

Generally, in a negative electrode of a lithium secondary battery, a negative electrode mixture layer containing a graphite-based negative electrode active material is formed on a negative electrode current collector. In the negative electrode mixture layer, pores are formed between particles of the graphite-based negative electrode active material, and the pore serves as a path through which lithium ions move during the charging and discharging process of the battery.

The negative electrode is manufactured by dispersing an electrode mixture containing a graphite-based negative electrode active material, a binder, and a conductive material in an organic solvent to produce a slurry, applying the slurry to the surface of the current collector, and then removing the organic solvent by evaporation, and increasing the electrode density by rolling. During the drying process and the rolling process of evaporating and removing the organic solvent, the particles constituting the electrode mixture, in detail, the anisotropic negative electrode active material such as graphite, are oriented in the horizontal direction and are distributed irregularly. Due to the horizontal orientation and irregular distribution as described above, pores formed between particles present in the negative electrode mixture layer are also distributed unevenly.

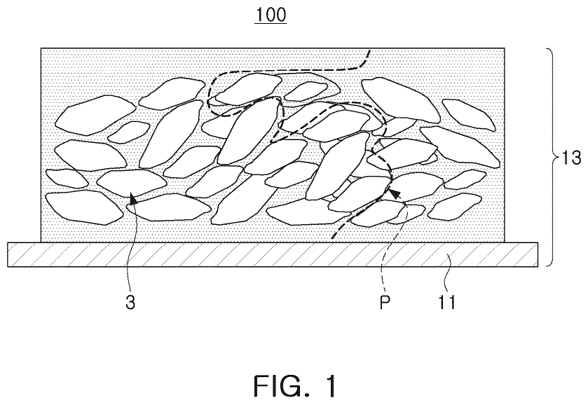

The distribution of the negative electrode active material and pores in this negative electrode mixture layer is schematically illustrated in FIG. 1. As illustrated in FIG. 1, a negative electrode active material 3 and pores in a negative electrode mixture layer 13, formed on a negative electrode current collector 11, are unevenly distributed and horizontally oriented, and as a result, tortuosity of the pores in the negative electrode mixture layer increases, and a distance of a path P along which lithium ions move greatly increases, thereby reducing rapid charging performance of the battery.

The high tortuosity of the pores in the negative electrode mixture layer acts as a conduction resistance for lithium ions as the rate increases during the charging process, causing polarization of the battery and deteriorating cell performance.

Recently, to prevent the problem of lowering a diffusion rate of lithium ions due to the horizontal orientation of the negative electrode active material as described above, a magnetic field has been applied to orient the current collector vertically, and as a result, technology to shorten the movement path of lithium ions has been applied to the production of negative electrodes. Using the magnetic properties of anisotropic graphite, which is used as a negative electrode active material, the negative electrode mixture is applied on the negative electrode current collector and then a magnetic field is applied, and thus, the negative electrode active material may be oriented perpendicular to the negative electrode current collector. In this manner, since the graphite in the negative electrode mixture layer is oriented in the vertical direction with respect to the negative electrode current collector, an effect of shortening a movement path of lithium ions may be obtained.

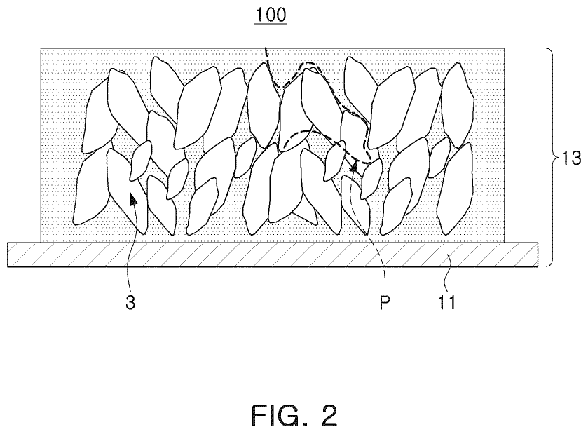

However, due to the overlapping of the negative electrode active material particles within the negative electrode mixture layer or the shape of the graphite negative electrode active material itself or the like, even if a magnetic field is applied, the lithium ion movement path may not be linear. This is schematically illustrated in FIG. 2. FIG. 2 is an illustrative diagram illustrating the negative electrode active material 3 and pores in the negative electrode mixture layer 13 in the negative electrode obtained by applying a magnetic field, and as illustrated in FIG. 2, not only does the lithium ion movement path P not have linearity, but in some cases, the lithium ion movement path P may be severely curved, or the movement path P may be blocked, and as a result, there are certain limits to improving fast charging performance due to the shortening of the travel distance of lithium ions.

The disclosed technology provides a negative electrode that may improve metal charging performance by shortening a movement path of lithium ions.

The negative electrode according to an embodiment includes a negative electrode current collector and a negative electrode mixture layer containing a negative electrode active material on at least one surface of the negative electrode current collector.

As the negative electrode current collector, as a non-limiting example, a material selected from the group consisting of copper foil, nickel foil, stainless steel foil, titanium foil, nickel foam, copper foam, a polymer substrate coated with a conductive metal, and combinations thereof may be used.

The thickness of the negative electrode current collector is not particularly limited and may be, for example, 10 to 50 μm.

In an embodiment, a negative electrode mixture in a slurry form is applied to the surface of the negative electrode current collector and dried to form a negative electrode mixture layer, and the negative electrode mixture includes a negative electrode active material and carbon fiber.

As the negative electrode active material, a material capable of adsorbing and desorbing lithium ions may be used. The negative electrode active material may include a carbon-based negative electrode active material. The carbon-based negative electrode active material may be suitably used in the disclosed technology as long as it is commonly used in the production of the negative electrode of lithium ion secondary batteries, and there is no particular limitation, but the carbon-based negative electrode active material may be graphite, and in detail, may be artificial graphite. As the negative electrode active material, the crystalline carbon-based material, which is artificial graphite or a mixture of artificial graphite and natural graphite, has more developed crystallographic characteristics of particles, and may thus have further improved orientation characteristics against external magnetic fields, compared to amorphous carbon-based active materials, thereby improving the orientation of pores in the negative electrode mixture layer.

As the negative electrode active material, the artificial graphite and natural graphite may be mixed and used, and when using a mixture of the artificial graphite and natural graphite, the artificial graphite and natural graphite may be mixed at a weight ratio of 70:30 to 95:5.

The form of the artificial graphite or natural graphite is not particularly limited, and may have various shapes such as amorphous, plate-shaped, flake-shaped, spherical, fibrous shapes, and the like, and may be a combination thereof.

In addition to the carbon-based negative electrode active material, the negative electrode mixture may further include at least one second negative electrode active material selected from the group consisting of a silicon (Si)-based negative electrode active material, an Sn-based negative electrode active material, or a lithium vanadium oxide negative electrode active material, if necessary. When the negative electrode mixture further includes the second negative electrode active material, the second negative electrode active material may be included in a range of 1 to 50% by weight based on the total weight of the negative electrode active material.

The Si-based negative electrode active material may be Si, Si—C composite, SiOx (0<x<2), or an Si-Q alloy, and the Q is an element other than Si, selected from the group consisting of alkali metals, alkaline earth metals, Group 13 elements, Group 14 elements, Group 15 elements, Group 16 elements, transition metals, rare earth elements, and combinations thereof, and in detail, may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and combinations thereof.

The Sn-based negative electrode active material may be Sn, SnO₂, or Sn—R alloy, and the R is not Sn or Si, but is an element selected from the group consisting of alkali metals, alkaline earth metals, Group 13 elements, Group 14 elements, Group 15 elements, Group 16 elements, transition metals, rare earth elements, and combinations thereof, and in detail, may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, In, Tl, Ge, P, As, Sb, Bi, S, Se, Te, Po, and combinations thereof, and further, at least one thereof may be mixed with SiO₂ and used.

The negative electrode active material may be contained in an amount of 94 to 98% by weight based on the solid weight of the negative electrode mixture.

The negative electrode mixture in the disclosed technology includes carbon fiber. The carbon fiber serves as a conductive agent and improves the degree of tortuosity of the lithium ion movement path in the negative electrode mixture layer, to enable the lithium ion movement path to be simpler and more straight, and may also contribute to shortening the travel route.

The effect of simplifying and shortening the lithium ion movement path by the carbon fiber may be obtained not only when the negative electrode active material is oriented by a magnetic field, but also in the negative electrode of the negative electrode active without orientation material.

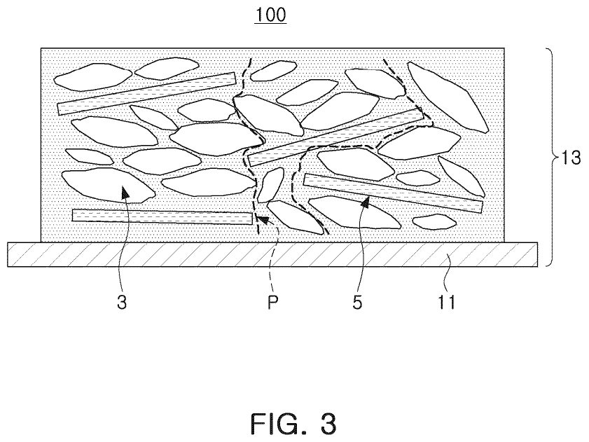

In detail, an embodiment of a negative electrode having a negative electrode mixture layer containing carbon fiber is schematically illustrated in FIG. 3. As illustrated in FIG. 3, as the carbon fiber 5 is present in the negative electrode mixture layer 13 formed on the negative electrode current collector 11, pores that serve as a movement path P for lithium ions may be formed between the particles of the negative electrode active material 3 along the outer side of the carbon fiber 5. At this time, the pores serving as the movement path P of lithium ions may be formed at least in part along the carbon fiber 5, thereby simplifying and shortening the movement path P.

In addition, as the carbon fiber is present in the negative electrode mixture layer, it is possible to alleviate the distortion of the movement path of lithium ions, which may occur even in a negative electrode in which the negative electrode active material is oriented in a direction perpendicular to the negative electrode current collector by applying a magnetic field, or the like.

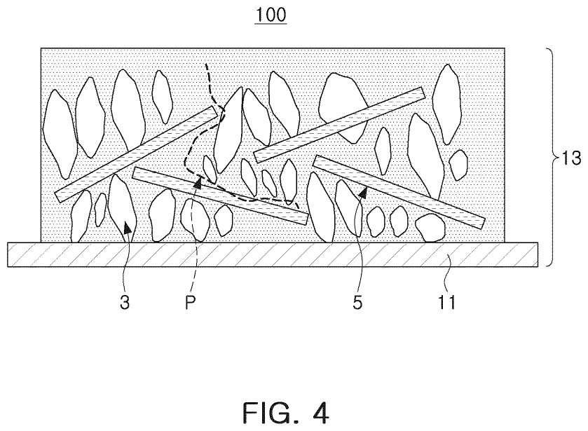

For example, an embodiment of a negative electrode having an oriented negative electrode mixture layer including carbon fiber is schematically illustrated in FIG. 4. As illustrated in FIG. 4, even in a negative electrode 100 having the negative electrode mixture layer 13 in which the negative electrode active material is oriented on the negative electrode current collector 11, as the carbon fiber 5 is included in the negative electrode mixture layer 13, straight pores serving as a movement path P for lithium ions may be formed between the particles of the negative electrode active material 3 along the outside of the carbon fiber 5. Accordingly, the movement path P of lithium ions is formed more linearly, and thus, the movement path P of lithium ions may be simplified and shortened.

In the disclosed technology, the term ‘vertical direction’ refers to the direction perpendicular to the plane of the negative electrode current collector. However, the vertical direction is not limited to being oriented at 90° with respect to the negative electrode current collector, and for example, includes being oriented at 30° or more, in detail, 45° or more, and in more detail, 60° or more. As illustrated in FIGS. 3 and 4, by including the carbon fiber 5 in the negative electrode mixture layer 13, a straight movement path P along the periphery of the carbon fiber 5 may be formed, and compared to the curved or zigzag movement path P illustrated in the negative electrode of FIGS. 1 and 2, the tortuosity, or degree of bending thereof may be significantly improved. Furthermore, in some cases, a straight movement path P may be provided in a direction perpendicular to the negative electrode current collector 11. Therefore, the negative electrode according to an embodiment may obtain the effect of shortening the movement path of lithium ions, and may improve fast charging performance.

To provide a straight lithium ion movement path as described above, the carbon fiber may have a degree of mechanical strength not to be easily bent by the solid components constituting the negative electrode mixture, in detail, the negative electrode active material. Therefore, the carbon fiber may have an average thickness in the range of 5 to 20 μm, but is not limited thereto. If the average thickness of the carbon fiber is less than 5 μm, it may be difficult to provide a straight movement path, and if it exceeds 20 μm, the volume ratio of the active material in the electrode mixture layer may decrease, resulting in a decrease in capacity, while in reduction in the number of carbon fibers that may be included in the electrode mixture layer, which may be disadvantageous in providing straight pores.

In this respect, it is distinguished from carbon fiber, which is commonly used as a conductive agent in electrode active materials. Carbon fibers, which are generally provided as conductive materials, may be used to provide good conductivity and have a smaller thickness than the carbon fibers used to provide straight pores in the disclosed technology, and for example, may have a thickness of 500 nm or less, for example, 10 to 500 nm, 50 to 500 nm, 50 to 300 nm, or 100 to 200 nm.

The carbon fiber may have, but is not limited to, a length of 30 μm or more. If the length of the carbon fiber is less than 30 μm, a straight lithium ion movement path may not be formed.

On the other hand, the length of the carbon fiber may be less than or equal to the thickness of the negative electrode mixture layer, but is not limited thereto. If the length of the carbon fiber is greater than the thickness of the negative electrode mixture layer, the carbon fiber may protrude from the surface layer of the negative electrode mixture layer, and may penetrate the separator and directly contact a positive electrode. Therefore, the length of the carbon fiber may vary depending on the thickness of the negative electrode mixture layer, and for example, may be 150 μm or less, 120 μm or less, 100 μm or less, or 80 μm or less.

The carbon fiber may be, but is not limited to, 0.5 to 10% by weight based on the total weight of the negative electrode mixture layer. For example, the carbon fiber may be included in an amount of 0.5% by weight or more, 1% by weight or more, 1.5% by weight or more, 2% by weight or more, or 2.5% by weight or more, and in an amount of 10% by weight or less, 7% by weight or less, 5% by weight or less, 4% by weight or less, or 3% by weight or less. If the content of the carbon fiber is less than 0.5% by weight, it may be insufficient to form straight pores throughout the negative electrode mixture layer provided as a lithium ion movement path, and if it exceeds 10% by weight, the content of the negative electrode active material may decrease, resulting in a decrease in capacity.

In an embodiment, the negative electrode mixture may include a binder. The binder binds the negative electrode active material particles to each other and also serves to bind the negative electrode active material to the negative electrode current collector. The binder may be a water-dispersible or water-soluble binder.

The binder may include, but is not limited to, styrene-butadiene rubber, acrylated styrene-butadiene rubber (SBR), acrylonitrile-butadiene rubber, acrylic rubber, butyl rubber, ethylene-propylene copolymer, polyepichlorohydrin, polyphosphazene, polyacrylonitrile, polystyrene, ethylene-propylene-diene copolymer, polyvinylpyridine, chlorosulfonated polyethylene, latex, polyester resin, acrylic resin, phenol resin, epoxy resin, polyvinyl alcohol resin and acrylate resin, which may be used individually or in combination of two or more types.

The content of the binder in the negative electrode active material layer may be 1.5 to 3% by weight based on the solid weight of the negative electrode mixture.

Along with the binder, a thickener may be included to adjust the viscosity of the negative electrode mixture slurry. Examples of the thickener may include cellulose-based compounds, and for example, one or more types of carboxymethylcellulose, hydroxypropylmethylcellulose, methylcellulose, or alkali metal salts thereof may be mixed and used. Na, K, or Li may be used as the alkali metal.

The thickener may be 0.1 to 3 parts by weight based on 100 parts by weight of the negative electrode active material.

The negative electrode mixture according to an embodiment may include a conductive agent to provide conductivity to the electrode. The conductive agent may be used without limitation as long as it is commonly used in secondary batteries. For example, as the conductive agent, carbon-based materials of natural graphite, artificial graphite, carbon black, acetylene black, ketjen black, denka black, thermal black, channel black, carbon fiber, carbon nanotube, graphene, or the like; metal-based materials of powders or fibers of metals or metal-containing compounds such as perovskite materials such as copper, nickel, aluminum, silver, tin, tin oxide, tin phosphate, titanium carbonate, potassium titanate, LaSrCoO₃, and LaSrMnO₃; conductive polymers such as polyphenylene derivatives or the like; or conductive materials including mixtures thereof may be used.

When a silicon-based negative electrode active material is included as the negative electrode active material, carbon nanotubes may be included as the conductive agent. When using a silicon-based negative electrode active material as a negative electrode active material and including the carbon nanotubes as a conductive agent, even if the active material particles are separated due to volume expansion during the charging and discharging process of the silicon-based negative electrode active material, relatively better conductivity may be provided.

When the conductive agent is a particulate material such as natural graphite, artificial graphite, carbon black, acetylene black, Ketjen black, metal powder, or the like, the particulate material having an average particle diameter of 500 nm or less, for example, 10 to 500 nm, may be used. Additionally, when the conductive agent is a fibrous material such as carbon fiber, carbon nanotube, or metal fiber, the fibrous material having an average fiber diameter of 500 nm or less may be used, and for example, may have an average fiber diameter of 10 to 500.

The conductive agent may be included in an amount of 0.1 to 3% by weight based on the solid content of the negative electrode mixture.

The negative electrode mixture as described above is mixed with a solvent to prepare a slurry, and the negative electrode mixture slurry is applied to the negative electrode current collector. The solvent is not particularly limited, and water such as pure water, deionized water, distilled water, ethanol, isopropanol, methanol, acetone, n-propanol, t-butanol, or the like may be used as the solvent.

The solvent may be used so that the solid content of the negative electrode mixture slurry is 30 to 65% by weight. If the solid content of the slurry is less than 30% by weight, the viscosity of the slurry is low and the slurry easily flows down, which reduces workability, and the number of applications of the slurry may be increased to secure a predetermined amount of adhesion. If it exceeds 65% by weight, the viscosity of the slurry is high and the spreadability of the slurry is poor, and thus it may be difficult to form a mixture layer of uniform thickness and workability may be reduced.

Operation of applying the negative electrode mixture slurry to at least one surface of the negative electrode current collector and applying a magnetic field may be included.

The coating process may be performed using methods such as gravure coating, slot die coating, multi-layer simultaneous die coating, imprinting, doctor blade coating, dip coating, bar coating, casting or the like, but the disclosure technology is not limited thereto.

By applying the magnetic field, the negative electrode active material contained in the negative electrode mixture slurry may be oriented. In detail, as illustrated in FIG. 4, the negative electrode active material may be oriented in a direction perpendicular to the negative electrode current collector. At this time, the carbon fibers in the negative electrode mixture layer support the vertically oriented negative electrode active material, and may provide straight pores that may induce the movement path of lithium ions to be formed in a straight line. Therefore, the movement speed of lithium ions may be further improved, thereby improving fast charging characteristics.

A magnetic field of 1,000 to 10,000 Gauss may be applied to orient the carbon fiber as described above. For example, the magnetic field may be 1,000 Gauss or more, 2,000 Gauss or more, or 3,000 Gauss or more, and may be 10,000 Gauss or less, 9,000 Gauss or less, 8,000 Gauss or less, 7,000 Gauss or less, or 6,000 Gauss or less.

The magnetic field is not particularly limited and, for example, may be applied for a period of 0.5 seconds or more and 10 seconds or less. For example, the magnetic field may be applied for a period of at least 0.5 seconds, at least 1 second, at least 2 seconds, or at least 3 seconds, and may be applied for 10 seconds or less, 9 seconds or less, 7 seconds or less, 6 seconds or less, or 5 seconds or less.

As described above, the negative electrode mixture slurry is applied to at least one surface of the negative electrode current collector, and after orienting the negative electrode active material by applying a magnetic field, or while orienting the negative electrode active material by applying a magnetic field, the slurry may be dried.

The drying is to remove the solvent contained in the negative electrode mixture, and general drying methods may be applied, and for example, hot air drying, or the like may be applied.

The drying process is not particularly limited, but may be carried out for 20 to 300 seconds, for example, 40 to 240 seconds, or 60 to 200 seconds, within the range of 60 to 180° C., in detail, 70 to 150° C.

After the drying, an operation of rolling the negative electrode mixture layer formed by drying may be included. The rolling is an operation of adjusting the thickness or density of the electrode mixture layer, and may use related art methods such as a roll press method, a plate press method or the like. Although not particularly limited, the thickness of the negative electrode mixture layer obtained by rolling may be, for example, 20 μm or more and 120 μm or less per side, and in detail, may be, for example, greater than or equal to 40 μm and less than or equal to 100 μm, or greater than or equal to 60 μm and less than or equal to 80 μm.

On the other hand, the negative electrode mixture layer may have, but is not limited to, a density of 1.5 g/cm³ or more, and for example, may have a density of 1.5 g/cm³ or more and 2.2 g/cm³ or less, or 1.5 g/cm³ or more and 2.0 g/cm³ or less.

The negative electrode mixture layer may be formed on one surface or both surfaces of the negative electrode current collector, and furthermore, the negative electrode mixture layer may be a single layer, or may be a multi-layer such as two or more layers, for example, two, three, or four layers.

When forming a multi-layered negative electrode mixture layer, the negative electrode mixture slurry is applied continuously or discontinuously multiple times, and may be dried and rolled at the same time, thereby forming the multi-layered negative electrode mixture layer. In this case, the drying process may be performed once, thereby simplifying the process. On the other hand, after applying and drying a first negative electrode mixture slurry, a second negative electrode mixture slurry may be sequentially applied and dried and then rolled, thereby forming the negative electrode mixture layer. In this manner, when the drying process is performed multiple times, the binder distribution may be controlled for each layer, and thus, binder migration may be suppressed.

The negative electrode according to an embodiment as described above is provided with a straight lithium ion path in the negative electrode mixture layer, and as a result, the path through which lithium ions move into the negative electrode may be shortened. This shortening of the diffusion path of lithium ions may improve charging and discharging efficiency at a high C-rate, thereby improving fast charging performance.

When the negative electrode is a multilayer negative electrode including two or more negative electrode mixture layers on one surface of the negative electrode current collector, the carbon fiber may be included in all layers of the negative electrode mixture layer, or may be included in some layers.

For example, in an embodiment, the negative electrode mixture layer may include a first layer including a first surface in contact with the negative electrode current collector, and a second layer including a second surface as an outer side of the negative electrode mixture layer located on the surface opposite to the first surface. In this case, the first layer may include carbon fiber.

For example, when the negative electrode mixture layer is a multilayer negative electrode with two or more layers, the further inside the negative electrode mixture layer, for example, the closer it is to the negative electrode current collector in the negative electrode mixture layer, ion conduction of lithium ions may become difficult. Therefore, as described above, as carbon fiber is included in the first layer, which is a negative electrode mixture layer located on the current collector side, ion conduction of lithium ions may be further improved.

As another embodiment, when the negative electrode mixture layer is a multi-layer of three or more layers, the carbon fiber contents may be different between two adjacent negative electrode mixture layers. In detail, the content of carbon fibers included in the negative electrode mixture layer located on the current collector side among the two layers may be greater than the content of carbon fibers included in the negative electrode mixture layer located on the surface side. For example, the content of carbon fibers included in respective layers may gradually decrease from the first layer including the first surface on the current collector side toward the second layer including the second surface which is an outer side of the negative electrode mixture layer. Accordingly, the content of carbon fiber included in the second layer may be minimal or carbon fiber may not be included therein. In this case, the content may refer to weight percent.

According to an embodiment, when other conditions are the same, a negative electrode containing carbon fiber may have a higher black-and-white value than a black-and-white value of a negative electrode not containing carbon fiber.

The black-and-white degree may be measured using a chromameter, and for example, the dE value may be measured with Konica Minolta's CR-410. In detail, for the negative electrode before and after orientation, which is the measurement target, at 10 points at intervals of 10 mm in the negative electrode width direction (a minor axis direction), the black-and-white degree may be measured using a black-and-white measuring device and respectively quantitatively measuring according to the color system of L* (black and white), a* (red-green), and b* (yellow-blue), and the average of the measured values may be expressed as dE, the black-and-white degree.

The black and white degree represents a difference in dE value of the negative electrode surface, and from the dE value, the degree of orientation of graphite in the negative electrode may be confirmed. The larger the black-and-white value, the better orientation of the negative electrode active material in a direction perpendicular to the negative electrode current collector.

The negative electrode according to an embodiment may have a black-and-white difference of 1.5 or more depending on the presence or absence of magnetic orientation, but the disclosed technology is not limited thereto. Therefore, as the negative electrode according to an embodiment, the negative electrode obtained by applying a magnetic field to the negative electrode may have a greater black-and-whiteness value of 1.0 or more than the black-and-whiteness value of the negative electrode obtained without applying a magnetic field to the negative electrode.

Furthermore, a negative electrode containing carbon fibers according to an embodiment may have a higher black-and-white value than a negative electrode that does not contain carbon fibers. For example, the negative electrode according to an embodiment including carbon fiber and oriented by applying a magnetic field may have a higher black-and-white value than a negative electrode that does not contain carbon fiber and is oriented by applying a magnetic field, and for example, may have a black-and-white value difference of about 1.5 or more.

In addition, as a negative electrode according to an embodiment, the negative electrode including carbon fiber and without applying a magnetic field may also have a higher black-and-white value than a negative electrode that does not contain carbon fiber and does not apply a magnetic field. For example, there may be a difference in black and white values of about 0.5 or more.

In the negative electrode according to an embodiment, carbon fibers included in the negative electrode mixture layer may serve as a support for the negative electrode active material. After applying the slurry-phase negative electrode mixture on the negative electrode current collector, a magnetic field is applied to orient the negative electrode active material, and therefore, the orientation of the negative electrode active material may be improved or maintained.

Therefore, as described above, the negative electrode obtained in an embodiment may have a higher black-and-white degree compared to the negative electrode that does not include carbon fiber, not only when a magnetic field is applied, but also when a magnetic field is not applied.

The negative electrode according to an embodiment may have a P/O (Preferred Orientation) value of 0.45 or less according to XRD analysis. The P/O is measured using XRD and is a value comparing the (002) peak intensity indicating the degree of orientation in the horizontal direction with respect to the current collector, and indicates the degree of orientation of the negative electrode active material. The smaller the P/O value is, the degree of vertical orientation of the negative electrode active material may be evaluated as excellent.

Additionally, the negative electrode according to an embodiment may have a mean tortuosity value of 1.24 or less, in more detail, 1.22 or less or 1.20 or less. The tortuosity is defined as Ls/Le, where Ls represents a bulk thickness of the porous media, and Le represents an average of path length passed when penetrating the porous media.

After analyzing the structure by X-ray microscope (XRM), an X-ray microscope analysis method for non-destructive high-resolution 3D imaging, the tortuosity may be obtained by calculating the Le and Ls values.

The smaller the average tortuosity value, the more linear the movement path of lithium ions is, meaning that the degree of bending is less. Accordingly, the mobility of lithium ions may be improved to improve rapid charging.

An electrode assembly is manufactured by alternately stacking the negative electrode obtained according to an embodiment with a positive electrode with a separator therebetween as a boundary, and then inserted into the battery case and sealing, and a lithium secondary battery may be manufactured by injecting electrolyte.

According to example embodiments, an electrode assembly may be formed by repeatedly disposing a positive electrode, a negative electrode, and a separator. In some embodiments, the electrode assembly may be of a winding type, a stacking type, a z-folding type, or a stack-folding type.

Hereinafter, the positive electrode will be described in more detail.

The positive electrode is not particularly limited, but the positive electrode mixture layer is formed by applying the positive electrode mixture to at least one surface of the positive electrode current collector, drying, and rolling, and any positive electrode commonly used in secondary batteries may be suitably used in the disclosed technology.

The positive electrode mixture includes a positive electrode active material, a binder, and a solvent, and includes a conductive agent if necessary, and may also include a thickening agent.

The positive electrode active material may include a compound (lithiated intercalation compound) capable of reversible insertion and desorption of lithium ions.

According to example embodiments, the positive electrode active material may include lithium-nickel metal oxide. The lithium-nickel metal oxide may further include at least one of cobalt (Co), manganese (Mn), and aluminum (Al).

In some embodiments, the positive electrode active material or the lithium-nickel metal oxide may include a layered structure or a crystal structure represented by Chemical Formula 1 below.

LiₓNiₐM_{b}O_{2+z} [Formula 1]

In Formula 1, it may be 0.9≤x≤1.2, 0.6≤a≤0.99, 0.01≤b≤0.4, and −0.5≤z≤0.1. As described above, M may include Co, Mn, and/or Al.

The chemical structure represented by Formula 1 represents the bonding relationship contained within the layered structure or crystal structure of the positive electrode active material and does not exclude other additional elements. For example, M includes Co and/or Mn, and Co and/or Mn may be provided as the main active element of the positive electrode active material along with Ni. Formula 1 is provided to express the bonding relationship of the main active elements and should be understood as encompassing the introduction and substitution of additional elements.

In an embodiment, in addition to the main active element, auxiliary elements to improve the chemical stability of the positive electrode active material or the layered structure/crystal structure may be further included. The auxiliary elements may be incorporated together into the layered/crystal structure to form bonds, and in this case, it should also be understood as being included within the scope of the chemical structure represented by Formula 1.

The auxiliary elements may include at least one of, for example, Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr. For example, the auxiliary element may act as an auxiliary active element, such as Al, together with Co or Mn, contributing to the capacity/output activity of the positive electrode active material.

For example, the positive electrode active material or the lithium-nickel metal oxide may include a layered structure or crystal structure represented by the following Chemical Formula 1-1.

LiₓNiₐM1_{b1}M2_{b2}O_{2+z} [Formula 1-1]

In Formula 1-1, M1 may include Co, Mn, and/or Al. M2 may include the auxiliary elements described above. In Formula 1-1, it may be 0.9≤x≤1.2, 0.6≤a≤0.99, 0.01≤b1+b2≤0.4, and −0.5≤z≤0.1.

The positive electrode active material may further include a coating element or a doping element. For example, elements substantially the same as or similar to the above-described auxiliary elements may be used as coating elements or doping elements. For example, any of the above-mentioned elements alone or in combination of two or more may be used as a coating element or a doping element.

The coating element or doping element is present on the surface of the lithium-nickel metal oxide particle, or penetrates through the surface of the lithium-nickel metal oxide particle, and may also be included in the bonding structure represented by Formula 1 or Formula 1-1.

The positive electrode active material may include nickel-cobalt-manganese (NCM)-based lithium oxide. In this case, NCM-based lithium oxide with increased nickel content may be used.

Ni may serve as a transition metal related to the output and capacity of lithium secondary batteries. Therefore, by adopting a high-Ni composition as the positive electrode active material as described above, a high-capacity positive electrode and a high-capacity lithium secondary battery may be provided.

However, as the Ni content increases, the long-term storage stability and lifetime stability of the positive electrode or secondary battery may be relatively reduced. Side reactions with electrolytes may also increase. However, according to example embodiments, life stability and capacity maintenance characteristics may be improved through Mn while maintaining electrical conductivity by including Co.

The content of Ni (for example, a mole fraction of nickel in the total number of moles of nickel, cobalt, and manganese) in the NCM-based lithium oxide may be 0.6 or more, 0.7 or more, or 0.8 or more. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the positive electrode active material may include a lithium cobalt oxide-based active material, a lithium manganese oxide-based active material, a lithium nickel oxide-based active material, or a lithium iron phosphate (LFP)-based active material (for example, LiFePO₄).

In some embodiments, the positive electrode active material may include, for example, an Mn-rich active material, Li rich layered oxide (LLO)/Over Lithiated Oxide (OLO)-based active material and a Co-less active material having a chemical structure or crystal structure represented by Formula 2.

p[Li₂MnO₃]·(1−p)[Li_{q}JO₂] [Formula 2]

In Formula 2, 0<p<1 and 0.9≤q≤1.2 may be satisfied, and J may include at least one element among Mn, Ni, Co, Fe, Cr, V, Cu, Zn, Ti, Al, Mg, and B.

In the positive electrode, the positive electrode active material may be 90 to 98% by weight based on the solid weight of the positive electrode mixture.

The binder binds the positive electrode active material particles to each other and also binds the positive electrode active material to the positive electrode current collector, and may be 1.5 to 5% by weight based on the solid weight of the positive electrode mixture.

Examples of the binder may include, for example, polyvinylidenefluoride (PVDF), vinylidene fluoride-hexafluoropropylene copolymer (Poly(vinylidene fluoride-co-hexafluoropropylene), polyacrylonitrile, polymethyl methacrylate, acrylonitrile butadiene rubber (NBR), polybutadiene rubber (BR), styrene-butadiene rubber (SBR), and the like. In an embodiment, a PVDF-based binder may be used as the positive electrode binder.

Along with the binder, a thickener may be further included to provide viscosity. In an embodiment, as the thickener, a thickener such as carboxymethyl cellulose (CMC) may be used. The thickener may be included in an amount of 0.1 to 3 parts by weight based on 100 parts by weight of the positive electrode active material.

The conductive agent may be added to improve the conductivity of the positive electrode mixture layer and/or the mobility of lithium ions or electrons. Any electronically conductive material commonly used in the positive electrode of a secondary battery may be suitably used. For example, the conductive agent may include carbon-based conductive materials such as graphite, carbon black, acetylene black, Ketjen black, graphene, carbon nanotubes, vapor-grown carbon fiber (VGCF), carbon fiber and the like, and/or metal-based conductive materials including perovskite materials such as tin, tin oxide, titanium oxide, LaSrCoO₃, and LaSrMnO₃, but the disclosed technology is not limited thereto. The conductive agent may be used in an amount of 0.1 to 5% by weight based on the solid weight of the positive electrode mixture.

The positive electrode mixture may also include carbon fibers that are distinct from the conductive agent, as included in the negative electrode. When the carbon fiber is included in the positive electrode mixture, as in the negative electrode, a straight lithium ion movement path may be provided around the carbon fiber, thereby shortening the lithium ion movement path.

The carbon fiber may be the same as that used in the negative electrode, and detailed description thereof will be omitted.

The solvent may be an aqueous solvent such as water or a non-aqueous solvent. As the non-aqueous solvent, any solvent commonly used in the production of positive electrode mixtures for secondary batteries may be used in the disclosed technology. Examples of the non-aqueous solvent may include N-methyl-2-pyrrolidone (NMP), dimethylformamide, dimethylacetamide, N, N-dimethylaminopropylamine, ethylene oxide, and tetrahydrofuran, but the disclosed technology is not limited thereto.

The solvent may be included so that the solid content of the positive electrode mixture slurry is 30 to 65% by weight, but the disclosed technology is not limited thereto.

An operation of applying the positive electrode mixture slurry to the surface of the positive electrode current collector is included. As the positive electrode current collector, any metal with good conductivity and commonly used in the production of positive electrodes for secondary batteries may be used, and for example, may include aluminum, nickel, titanium, stainless steel, or alloys thereof, and aluminum or stainless steel surface treated with carbon, nickel, titanium, or silver may be used, which may be in various forms such as sheet, foil, mesh type, and the like.

The thickness of the positive electrode current collector is not particularly limited and may be, for example, 10 to 50 μm.

As described above for the negative electrode manufacturing process, by applying the positive electrode mixture slurry to one or both surfaces of the positive electrode current collector, and then performing a drying process, and then rolling, a positive electrode in which a positive electrode mixture layer is formed on a positive electrode current collector may be manufactured.

The coating process may be performed using methods such as gravure coating, slot die coating, multi-layer simultaneous die coating, imprinting, doctor blade coating, dip coating, bar coating, casting, and the like, but the disclosed technology is not limited thereto. The drying and rolling process may be performed by the same method as the production of the negative electrode, and detailed description thereof is omitted.

A separator may be interposed between the positive electrode and the negative electrode. The separator may be configured to prevent an electrical short circuit between the positive electrode and the negative electrode and to generate a flow of ions. The separator may include a porous polymer film or a porous non-woven fabric. The porous polymer film may include polyolefin-based polymers such as ethylene polymer, propylene polymer, ethylene/butene copolymer, ethylene/hexene copolymer, ethylene/methacrylate copolymer, and the like.

The porous nonwoven fabric may include high melting point glass fiber, polyethylene terephthalate fiber, or the like. The separator may include a ceramic-based material, and for example, inorganic particles may be coated on the polymer film or dispersed within the polymer film to improve heat resistance.

The separator may have a single-layer or multi-layer structure including the polymer film and/or non-woven fabric described above.

The separator is not particularly limited, but may have a thickness of about 10 to 40 μm, for example, 10 to 20 μm.

According to an embodiment, in the lithium secondary battery of the disclosed technology, the electrode assembly may be accommodated in the battery case, and electrolyte solution may be injected. The electrolyte solution includes a non-aqueous organic solvent and a lithium salt. The non-aqueous organic solvent may serve as a medium through which ions involved in the electrochemical reaction of the battery may move.

According to example embodiments, a non-aqueous electrolyte solution may be used as the electrolyte solution. The non-aqueous electrolyte solution may include lithium salt as an electrolyte and an organic solvent.

The non-aqueous organic solvent serves as a medium through which ions involved in the electrochemical reaction of the battery may move, has sufficient solubility in the lithium salt and additives, and may contain organic compounds that are not reactive within the battery. For example, the organic solvent may include at least one of a carbonate-based solvent, an ester-based solvent, an ether-based solvent, a ketone-based solvent, an alcohol-based solvent, and an aprotic solvent.

As the organic solvent, for example, propylene carbonate (PC), ethylene carbonate (EC), butylene carbonate, diethyl carbonate (DEC), dimethyl carbonate (DMC), ethylmethyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfuroxide, acetonitrile, diethoxyethane, sulfolane, gamma-butyrolactone, propylene sulfite, and the like may be used. These may be used alone or in combination of two or more.

The lithium salt is dissolved in an organic solvent and acts as a source of lithium ions in the battery, enabling the basic operation of a lithium secondary battery, and may serve the role of promoting the movement of lithium ions between the positive electrode and the negative electrode.

The lithium salt is expressed, for example, as Li⁺X⁻, and as the anion (X⁻) of the lithium salt, for example, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, and the like may be used, by way of example. Thereamong, one type may be used, or two types or more may be mixed and used.

The concentration of the lithium salt is not particularly limited, but may be used within the range of 0.1M to 2.0M.

The non-aqueous electrolyte solution may further include additives. The additives may include, for example, a cyclic carbonate-based compound, a fluorine-substituted carbonate-based compound, a sultone-based compound, a cyclic sulfate-based compound, a cyclic sulfite-based compound, a phosphate-based compound, and a borate-based compound.

The cyclic carbonate-based compound may include vinylene carbonate (VC), vinyl ethylene carbonate (VEC), or the like.

The fluorine-substituted carbonate-based compound may include a fluorine-substituted cyclic carbonate-based compound such as fluoroethylene carbonate (FEC), or the like.

The sultone-based compound may include 1,3-propane sultone, 1,3-propene sultone, 1,4-butane sultone, or the like.

The cyclic sulfate-based compound may include 1,2-ethylene sulfate, 1,2-propylene sulfate, or the like.

The cyclic sulfite-based compound may include ethylene sulfite, butylene sulfite, or the like.

The phosphate-based compound may include lithium difluoro bis-oxalato phosphate, lithium difluoro phosphate, or the like.

The borate-based compound may include lithium bis(oxalate) borate or the like.

As described above, in an embodiment of the disclosed technology, a movement path of lithium ions may be shortened and rapid charging characteristics may be improved by providing a straight lithium ion movement path within the negative electrode.

### EXAMPLE

Hereinafter, examples of the disclosed technology will be described in more detail. The following examples show detailed embodiments according to the disclosed technology, and are not intended to limit the invention of the disclosed technology thereby.

### Example 1

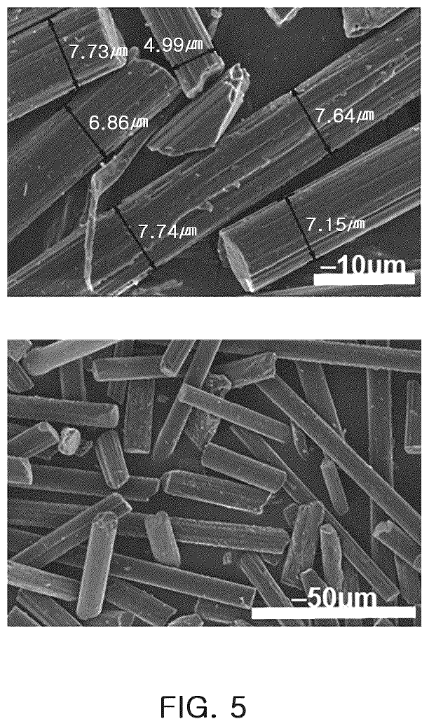

Based on the solid weight of the negative electrode mixture, 88.93% by weight of graphite, 8.10% by weight of SiOx (0<x<2), 1.3% by weight of SBR, 1.2% by weight of CMC, and 0.47% by weight of carbon fiber (an average thickness of 7 μm, an average length of 60 μm) were added to the water, thereby preparing a negative electrode mixture slurry. The solid content of the negative electrode mixture slurry was 46.3% by weight. The carbon fiber was photographed by SEM and the images are illustrated in FIG. 5.

The viscosity of the negative electrode mixture slurry was measured, and the results are illustrated in Table 1.

By applying the negative electrode mixture slurry to both sides of the copper foil, and by drying at 200° C. for 1 minute while passing through a facility in which a magnetic field is applied from both upper and lower surfaces of the electrode under the conditions of 4,000 Gauss, 4 seconds and moving speed of 2.1 m/sec, and then by rolling, a negative electrode with a density of 1.60 g/cm³ was obtained.

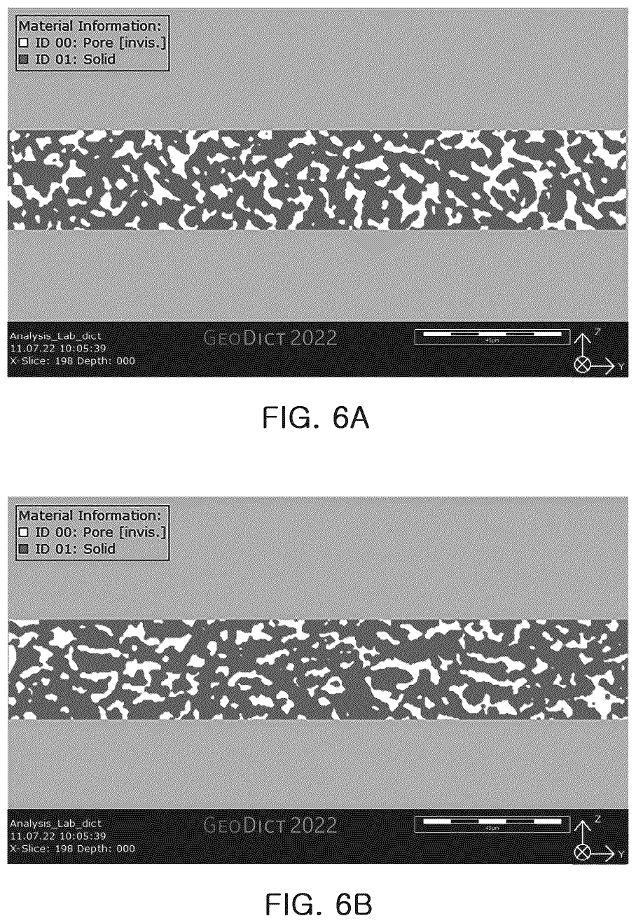

The cross-sectional structure of the obtained negative electrode was analyzed by XRM, and the image is illustrated in FIG. 6A.

Furthermore, the electrode resistance, interface resistance, black-and-white degree, P/O, and mean tortuosity of the obtained negative electrode were measured by the following methods, and the results are illustrated in Table 1.

Electrode Resistance and Interface Resistance: Resistance was measured using a four-terminal resistance meter.

P/O: A numerical value of the peak intensity of the (002) plane of graphite, which indicates the degree of in-plane orientation in the horizontal direction with the negative electrode current collector, is an indicator of the degree of orientation of the negative electrode active material, and the smaller the value, the better the degree of orientation.

Black-and-White Degree and P/O: For the negative electrode, the black-and-white degree of the coated negative electrode was measured using a black-and-white degree measuring device at 10 points at 10 mm intervals in the negative electrode width direction (minor axis direction), and the measured black-and-white degrees were averaged to determine a black-and-white degree. On the other hand, Preferred Orientation (P/O), which indicates the degree of orientation of the negative electrode active material, was measured using XRD. The larger the black-and-white value, the better the vertical orientation of the negative electrode active material is. The smaller the P/O value, the better the vertical orientation of the negative electrode active material.

To evaluate the difference in the black-and-white degree, a reference negative electrode was manufactured by drying and rolling under the same conditions without passing through a facility to which a magnetic field is applied. The black-and-white degrees of the reference negative electrode and the negative electrode of Example 1 were respectively measured, and the difference was calculated and illustrated in Table 1.

Mean Tortuosity: Tortuosity is calculated as Ls/Le, where Ls represents the thickness of the negative electrode mixture layer, and Le represents an average ow path length passed when lithium ions pass through the negative electrode mixture layer and reach the negative electrode current collector.

The Le and Ls were measured by x-ray microscope ((XRM), the model name Xradia 620 Versa by ZEISS), an X-ray microscopic analysis method for non-destructive high-resolution 3D imaging.

### Comparative Example 1

Based on the solid weight of the negative electrode mixture, 88.93% by weight of graphite, 8.10% by weight of SiOx, 1.3% by weight of SBR, 1.2% by weight of CMC, and 0.47% by weight of CNT (average thickness of 3.5 nm, average length of 25 μm) were added to water, thereby preparing a negative electrode mixture slurry. The solid content of the negative electrode mixture slurry was 36.24% by weight.

The viscosity of the negative electrode mixture slurry was measured, and the results are illustrated in Table 1.

The negative electrode mixture slurry was applied to both sides of the copper foil in the same manner as Example 1, and in the same manner as in Example 1, was dried while passing through a facility in which a magnetic field was applied on both the upper and lower sides of the electrode, and then rolled, thereby obtaining a negative electrode with a density of 1.60 g/cm³.

The cross-sectional structure of the obtained negative electrode was analyzed by XRM, and the image is illustrated in FIG. 6B.

Electrode resistance, interfacial resistance, black/white degree difference, P/O, and mean tortuosity values were measured for the obtained negative electrode, and the results are illustrated in Table 1.

To evaluate the difference in black-and-white degrees, a reference negative electrode was manufactured by drying and rolling under the same conditions without passing through a facility to which a magnetic field is applied. The black-and-white degrees of the reference negative electrode and the negative electrode of Comparative Example 1 were respectively measured, and the difference was calculated and is illustrated in Table 1.

TABLE 1

| | | | | Black- | | |
|---|---|---|---|---|---|---|
| | | Electrode | | and- | | |
| Conduc- | | Resis- | Interfacial | White | | Mean |
| tive | Viscosity | tance | Resistance | Degree | | Tort- |
| Agent | (cP) | (Ω · cm) | (Ω · cm) | Difference | P/O | uosity |
| Example | 6770 | 0.06214 | 0.001417 | 2.06 | 0.48 | 1.19 |
| 1 | | | | | | |
| Com- | 7403 | 0.06717 | 0.001745 | 1.14 | 0.58 | 1.26 |
| parative | | | | | | |
| Example | | | | | | |
| 1 | | | | | | |

As can be seen from the viscosity values illustrated in Table 1, Example 1 showed a lower viscosity value than Comparative Example 1 even when the solid content was higher than the solid content of Comparative Example 1. From these results, it can be seen that Example 1 has a viscosity that may produce a negative electrode while reducing the solvent content, contributing to improving the productivity of the negative electrode. This is because the carbon fiber used in Example 1 and the CNT of Comparative Example 1 have different density values of 1.75 to 1.93 g/cm³ and 1.3 g/cm³, respectively, and this contributed to reducing the solvent content by providing a difference in volume fraction within the negative electrode mixture slurry.

In addition, as can be seen from Table 1, the negative electrode of Example 1 was confirmed to have an electrode resistance value at the same level as an electrode resistance value of Comparative Example 1. Therefore, it can be seen that the same level of conductivity may be secured even when using the carbon fiber as in Example 1.

In addition, from the interface resistance value between the electrode and the current collector, it was found that although carbon fiber was used in Example 1, the electronic conductivity at the interface did not decrease compared to the case containing CNTs in Comparative Example 1.

Furthermore, for both the negative electrodes of Example 1 and Comparative Example 1, an orientation process was performed by applying a magnetic field after applying the negative electrode mixture. As a result, the negative electrode of Example 1 showed a decrease in P/O value measured through XRD analysis, compared to Comparative Example 1. From these results, it can be seen that, along with the orientation of the negative electrode active material, the carbon fibers introduced into the negative electrode mixture layer support the oriented negative electrode active material, and in addition, provide a movement path for lithium ions through the surrounding pores created by the carbon fiber.

Furthermore, according to Example 1, in the case of including carbon fiber, the difference in black-and-white degree between the negative electrodes obtained depending on whether a magnetic field was applied or not was as large as 2.06, while in Comparative Example 1, the difference in black-and-white degree between the negative electrodes obtained depending on whether a magnetic field was applied or not was as small as 1.14.

In Example 1, the carbon fibers included in the negative electrode mixture layer were able to maintain orientation by supporting the magnetic-oriented negative electrode active material. Meanwhile, in the case of Comparative Example 1, the orientation of the negative electrode active material was not partially maintained because there was no support that could support the oriented negative electrode active material after magnetic orientation, and thus, it is evaluated that the result showed a small difference in black and white values depending on the presence or absence of a magnetic field.

Furthermore, it was found that the mean tortuosity of the negative electrode obtained in Example 1 was reduced compared to Comparative Example 1, thereby providing a more linear lithium ion movement path. From these results, it can be seen that the negative electrode of Example 1 will have superior ion conduction characteristics.

Furthermore, from the drawings illustrated in FIGS. 6A and 6B, it can be seen that the negative electrode obtained in Example 1 has more developed pores than pores of the negative electrode obtained in Comparative Example 1 and thus has excellent porosity characteristics. This may be evaluated as showing a tendency to match the average tortuosity value.

As set forth above, according to an embodiment, a movement speed of lithium ions during rapid charging may be significantly improved by including linear pores in a negative electrode mixture layer.

A negative electrode according to an embodiment may be widely applied in green technology fields such as secondary batteries, energy storage devices, and the like. In addition, a secondary battery including a negative electrode according to an embodiment may be used in eco-friendly electric vehicles, hybrid vehicles and the like to prevent climate change by suppressing air pollution and greenhouse gas emissions.

Only specific examples of implementations of certain embodiments are described. Variations, improvements and enhancements of the disclosed embodiments and other embodiments may be made based on the disclosure of this patent document.

What is claimed is:

1. A negative electrode comprising:
a negative electrode current collector; and
a negative electrode mixture layer on at least one surface of the negative electrode current collector,
wherein the negative electrode mixture layer includes a negative electrode active material and carbon fiber, and
the carbon fiber has an average cross-sectional diameter of 5 to 20 μm.

2. The negative electrode of claim 1, wherein the negative electrode mixture layer includes a first layer including a first surface in contact with the negative electrode current collector and a second layer including a second surface outside the negative electrode mixture layer located on a surface opposite to the first surface, and
wherein the negative electrode includes the carbon fiber in the first layer.

3. The negative electrode of claim 2, further comprising at least one negative electrode mixture layer between the first layer and the second layer,
wherein among two adjacent layers, a weight of the carbon fiber in the negative electrode mixture layer adjacent to the first surface is greater than a weight of the carbon fiber in the negative electrode mixture layer adjacent to the second surface.

4. The negative electrode of claim 3, wherein the second layer includes or does not include the carbon fiber.

5. The negative electrode of claim 1, wherein the carbon fiber has an average length of 30 to 150 μm.

6. The negative electrode of claim 1, wherein the carbon fiber has a density of 1.75 to 1.93 g/cm³.

7. The negative electrode of claim 1, wherein the carbon fiber is contained in an amount of 0.5 to 10% by weight based on a total weight of the negative electrode mixture layer.

8. The negative electrode of claim 1, wherein the negative electrode active material includes graphite.

9. The negative electrode of claim 1, wherein the negative electrode has a P/O value of 0.45 or less according to XRD analysis.

10. The negative electrode of claim 1, wherein the negative electrode active material has an orientation, perpendicular to the negative electrode current collector.

11. The negative electrode of claim 1, wherein the negative electrode has a mean tortuosity value of 1.24 or less.

12. The negative electrode of claim 1, wherein the negative electrode further includes a conductive agent, and
wherein the conductive agent further comprises at least one selected from a particulate conductive agent having an average particle diameter of 10 to 500 nm and a fibrous conductive agent having an average fiber diameter of 10 to 500 nm.

13. A secondary battery comprising a positive electrode and the negative electrode of claim 1.
